(19) United States
(12) Patent Application Publication
(10) Pub. No.: US 2021/0207043 A1
(43) Pub. Date: Jul. 8, 2021

(54) VCC SLURRY MID REACTOR SEPARATION

(71) Applicant: Cassandra Schoessow, Pearland, TX (US)

(72) Inventor: Cassandra Schoessow, Pearland, TX (US)

(73) Assignee: KELLOGG BROWN & ROOT LLC, Houston, TX (US)

(21) Appl. No.: 17/144,096

(22) Filed: Jan. 7, 2021

Related U.S. Application Data
(60) Provisional application No. 62/958,140, filed on Jan. 7, 2020.

(51) Int. Cl. C10G 65/10; C10G 47/26; B01J 8/00; B01J 8/08

(52) U.S. Cl. CPC C10G 65/10; C10G 47/26; B01J 8/0055; B01J 8/0085; C10G 2300/4081; C10G 2300/1077; C10G 2300/107; C10G 2300/708; B01J 8/08

(57) ABSTRACT

A system for separating first reactor effluent product by means of an intermediate separator, and sending the unconverted slurry material from the separator to further reactors. Such intermediate separation decreases the required size of downstream reactors.

### CROSS-REFERENCE TO RELATED APPLICATION

This application claims the benefit of U.S. Provisional Application Ser. No. 62/958,140 filed Jan. 7, 2020, incorporated herein by reference in its entirety.

### BACKGROUND

### 1. Field

The present disclosure relates to slurry phase reactors and methods for processing hydrocarbons such as residual oil.

### 2. Description of the Related Art

A conventional process for processing hydrocarbon feeds is a slurry-phase reactor hydrocracking technology, such as in an up-flow bubble column reactor. This slurry phase process, commonly referred to as VCC technology, generally includes two main reaction processes, namely, a liquid phase hydrogenation treatment (LPH), which mainly cracks the hydrocarbon feed, and gas phase hydrogenation (GPH), which treats and further cracks the hydrocarbons. Generally, a residual oil feed is first mixed with one or more additives and hydrogen. Next, the combined feed enters a bubble column reactor with hydrogen under high pressure and temperature, which causes a thermal cracking reaction. The cracking reaction is typically induced by increased temperatures (thermal cracking) or by an acid catalyst (catalytic cracking). Hydrocracking is a particular type of cracking reaction that takes place in a hydrogen rich environment. The additive may or may not increase chemical reactions with the hydrocarbon feed. Additional hydrodesulfurization (hydrotreating sulfur-containing compounds to produce hydrogen sulfide byproduct), hydrodenitrogenation (hydrogenating nitrogen-containing compounds to product ammonia byproduct), olefin saturation, aromatic saturation, and isomerization reactions may also take place. Afterwards, the product enters a separator to produce a vaporous converted product and a liquid slurry unconverted product.

Referring to FIG. 1, there is shown a prior art slurry phase reactor and separation system 10 for converting a vacuum residue into lighter, more valuable products. The system 10 may include a plurality of reactors 12, 14, 16, a hot separator 18, and a cyclone 20. A hydrocarbon feed 22 is directed into the serially-arranged reactors 12, 14, 16, which operate between 100 and 350 bar, and typically at about 200 bar. The hydrocarbon feed 22 may be a vacuum residue feed, slurry oils, coal tars, visbreaker tars, atmospheric residue, a coal feed, etc. Alternative hydrocarbon feeds may contain bitumen, coal+hydrocarbon oil mixture, mixtures of plastic and residue, mixtures of biomass and petroleum. Additives, such as carbonaceous type material, may be added to the feed 22. Other additives may contain iron or other metal based catalyst, carbon type impregnated with various metals, sodium salts. The product from the reactors 12, 14, 16 exit as a three phase mix of vapor, liquid, and solids. After cooling the mix to stop further cracking reactions and reduce coke forming reactions using a variety of methods including heat exchanging with cooler streams, injection of Hz, and injection of liquid hydrocarbon such as gas oil, the product is sent to the hot separator 18, which forms a first stream 24 composed of unconverted liquid slurry material and the additive(s) and a second lighter gaseous fluid stream 26. The vapor product 26 is sent to the cyclone 20. The cyclone 20 is a separator that uses inertia and a spiral vortex to remove small droplets of liquid and solid particles before the fluid streams enters a gas phase (GPH) reactor for further hydroprocessing. The GPH reactor can be a hydrotreater or a mix of hydrotreating and hydrocracking reactors.

Primary conversion within the LPH Reactors benefits from a stable back-mixed reactor flow regime, which is affected by superficial vapor velocity, liquid, and solid content. While high vapor rates tend to increase the back-mixing, they also necessitate larger reactor vessels, increasing the unit cost. Additionally, extremely high vapor rates can lead to instability in the back-mixed flow regime, affecting residue conversion. Over-conversion of the residue feed can result in malfunction of the unit, resulting from coking of the equipment and inability of the unit to remove the coke and solids from the unit.

The present disclosure addresses these and other drawbacks of the prior art.

### SUMMARY

In aspects, the present disclosure provides a system for processing a hydrocarbon feed. The system may include a plurality of serially aligned reactors; a hot separator receiving an effluent from the plurality of serially aligned reactors, the hot separator producing a first converted vapor product and a first unconverted slurry product; and an intermediate separator receiving an effluent from a first reactor of the plurality of reactors, the intermediate separator producing a second converted vapor product and an second unconverted slurry product, the second unconverted slurry product being directed into a second reactor of the plurality of reactors.

In aspects, the present disclosure provides a method for processing a hydrocarbon feed. The method includes feeding the hydrocarbon feed into a plurality of serially aligned reactors; receiving an effluent from the plurality of serially aligned reactors in a hot separator, the hot separator producing a first converted vapor product and a first unconverted slurry product; receiving an intermediate effluent from a first reactor of the plurality of reactors in an intermediate separator, the intermediate separator producing a second converted vapor product and an second unconverted slurry product; and directing the second unconverted slurry product into a second reactor of the plurality of reactors.

It should be understood that examples of certain features of the disclosure have been summarized rather broadly in order that the detailed description thereof that follows may be better understood, and in order that the contributions to the art may be appreciated. There are, of course, additional features of the disclosure that will be described hereinafter and which will in some cases form the subject of the claims appended thereto.

### BRIEF DESCRIPTION OF THE DRAWINGS

For detailed understanding of the present disclosure, references should be made to the following detailed description of the preferred embodiment, taken in conjunction with the accompanying drawings, in which like elements have been given like numerals and wherein:

FIG. 1 schematically illustrates a prior art VCC slurry phase reactor and separation system; and

FIG. 2 schematically illustrates one embodiment of a VCC slurry phase reactor and separation system according to the present disclosure.

### DETAILED DESCRIPTION

Referring to FIG. 2, there is shown a slurry phase reactor and separation system 30 in accordance with one embodiment of the present disclosure for producing products such as naphtha, diesel, and gas oil from a hydrocarbon feed 22. The hydrocarbon feed may include coal tar, slurry oil, atmospheric residues, vacuum residues, coals, etc. The feed 22 may include a lighter material, which is defined as a material having a normal boiling point above 500° C. The system 30 may include a plurality of serially-arranged reactors 32, 34, 36 and a main hot separator 38. The reactors 32, 34, 36 may be any vessel having a body suitable for reacting three-phases, i.e., solids, liquids, and gases, simultaneously, to form contents using an upward flowing, back-mixed flow regime. The reactors are VCC slurry phase or Liquid Phase (LPH) Reactors and operated at between 100-350 bar, and typically approximately 200 bar. The reactors 32, 34, 36 may include bubble columns that allow hydrocarbons, hydrogen and additives to enter the bubble column from the bottom. The contents are backmixed in each reactor with three phase (i.e., gas, liquid, solid) material exiting the top of the reactor. Solid additives fed into the reactor helps increase the residence time of liquid in the reactors and helps residue conversion.

In embodiments, an intermediate separator 50 may be inserted between two of the reactors 32, 34, 36. For instance, the intermediate separator 50 may be positioned to receive an effluent 38 from the reactor 32 and configured to form two products, a vaporous reactor conversion product 52 and an unconverted residue and solids product slurry 54. A hydrogen feed 56 may be added to the unconverted residue and solids product slurry 54. The separator 50 is configured to reduce the amount of hydrocarbon vapor in the effluent 38 from the reactor 32, which would otherwise reduce the hydrogen partial pressure in the downstream reactors 34, 36. Such a reduction would negatively impact the conversion efficiency of the residue and the prevention of coke in the reactors 34, 36. The reduction of feed to the subsequent reactors decreases their size and hence the overall equipment cost. The vapor product 52 may be sent to a GPH reactor (not shown) for further processing, or to a cooling unit (not shown) if there is no GPH reactor. The intermediate and main separators 50, 38 may be hot separators. The reduction of hydrocarbon vapor may be, by molecular weight, 1%, 5%, 10%, 20%, 30%, or more than 30%.

In one mode of operation, the hydrocarbon feed 22 is sent to an initial reactor 32 wherein the feed 22 is reacted with one or more additives, such as a carbonaceous additive, and hydrogen. The effluent 38 from the reactor 32 is directed into the intermediate separator, which separates the vapors into the vapor stream product 52 and the unconverted product slurry 54. Hydrogen 56 is added via a suitable line to the slurry 54 prior to entering the next reactor 34. After being reacted in downstream reactors 34, 36, the reactor outlet slurry is sent to the hot separator 38. The hot separator 38 separates the reactor outlet slurry into to the converted vapor product 22 and the unconverted residue and solids product slurry 58. The converted vapor product 22 may be sent to a cyclone separator, a cooling unit, a fixed bed Gas Phase (GPH) reactor, or otherwise sent for further processing.

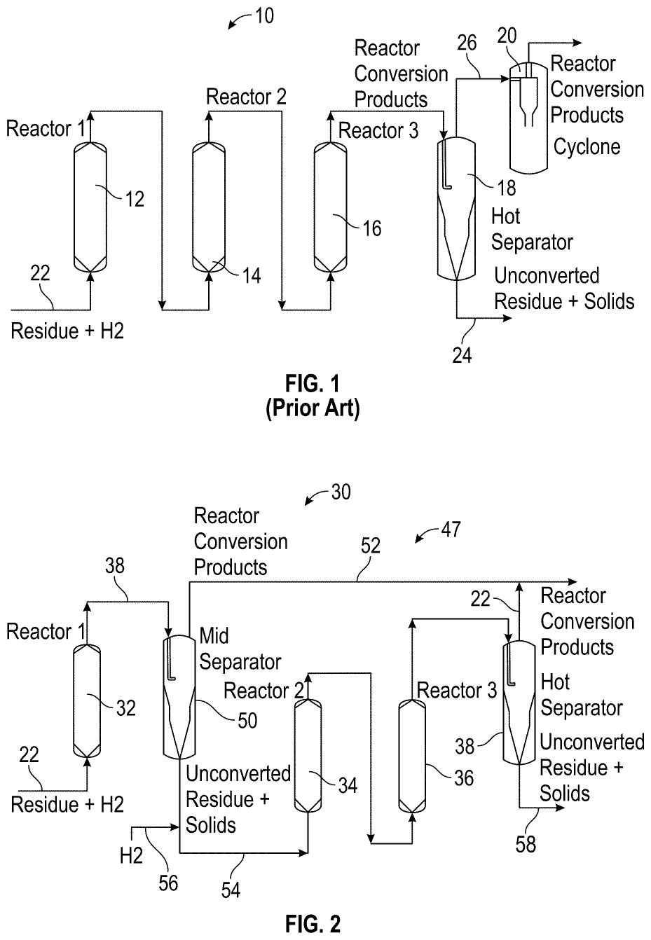

It should be understood that the system 30 of FIG. 1 is merely illustrative. Some embodiments may include only two reactors. Other embodiments may include four or more reactors. Also, the intermediate separator may not necessarily be between the first and the second separators. Some embodiments may interpose the intermediate separator between reactors further downstream, e.g., between the second and third, the third and fourth, etc. Also, in some embodiments, two or more intermediate separators may be used; e.g., between the first and the second reactors and also between the second and the third reactors.

Some components of the system 30 are described in U.S. Pat. No. 4,851,107, the contents of which are incorporated by reference for all purposes. While the foregoing is directed to embodiments of the present disclosure, other and further embodiments of the disclosure may be devised without departing from the basic scope thereof, and the scope thereof is determined by the claims that follow. For instance, a cyclone separator may be installed downstream of or inside the separators 38 and 50.

From the above, it should be appreciated that what has been described includes, in part, a system for processing a hydrocarbon feed. The system may include a plurality of serially aligned reactors; a hot separator receiving an effluent from the plurality of serially aligned reactors, the hot separator producing a first converted vapor product and a first unconverted slurry product; and an intermediate separator receiving an intermediate effluent from a first reactor of the plurality of reactors, the intermediate separator producing a second converted vapor product and an second unconverted slurry product, the second unconverted slurry product being directed into a second reactor of the plurality of reactors.

From the above, it should be appreciated that what has been described includes, in part, a method for processing a hydrocarbon feed. The method may include feeding the hydrocarbon feed into a plurality of serially aligned reactors; receiving an effluent from the plurality of serially aligned reactors in a hot separator, the hot separator producing a first converted vapor product and a first unconverted slurry product; receiving an intermediate effluent from a first reactor of the plurality of reactors in an intermediate separator, the intermediate separator producing a second converted vapor product and an second unconverted slurry product; and directing the second unconverted slurry product into a second reactor of the plurality of reactors.

Optionally, the system and/or method may also include a line conveying the second converted vapor product to one of: (i) a cyclone separator, (ii) a cooling unit, and (iii) a fixed bed Gas Phase reactor. In some embodiments, at least one of the plurality of serially aligned reactors is configured to receive one of: (i) a carbonaceous additive, and (ii) hydrogen. In some embodiments, the intermediate separator is configured to reduce hydrocarbon vapor in the effluent received from the first reactor. In some embodiments, at least one of the plurality of serially aligned reactors includes a bubble column allowing entry from a bottom of the bubble column one of: (i) a hydrocarbon, (ii) hydrogen, and (iii) an additive. In some embodiments, a line supplies a hydrogen feed to the second unconverted residue and solids product slurry.

What is claimed is:

1. A system for processing a hydrocarbon feed, comprising:
a plurality of serially aligned reactors;
a hot separator receiving an effluent from the plurality of serially aligned reactors, the hot separator producing a first converted vapor product and a first unconverted slurry product; and
an intermediate separator receiving an intermediate effluent from a first reactor of the plurality of reactors, the intermediate separator producing a second converted vapor product and an second unconverted slurry product, the second unconverted slurry product being directed into a second reactor of the plurality of reactors.

2. The system of claim 1, further comprising a line conveying the second converted vapor product to one of: (i) a cyclone separator, (ii) a cooling unit, and (iii) a fixed bed Gas Phase reactor.

3. The system of claim 1, wherein at least one of the plurality of serially aligned reactors is configured to receive one of: (i) a carbonaceous additive, and (ii) hydrogen.

4. The system of claim 1, wherein the intermediate separator is configured to reduce hydrocarbon vapor in the effluent received from the first reactor.

5. The system of claim 1, wherein at least one of the plurality of serially aligned reactors includes a bubble column allowing entry from a bottom of the bubble column one of: (i) a hydrocarbon, (ii) hydrogen, and (iii) an additive.

6. The system of claim 1, further comprising a line supplying a hydrogen feed to the second unconverted residue and solids product slurry.

7. A method for processing a hydrocarbon feed, comprising:
feeding the hydrocarbon feed into a plurality of serially aligned reactors;
receiving an effluent from the plurality of serially aligned reactors in a hot separator, the hot separator producing a first converted vapor product and a first unconverted slurry product;
receiving an intermediate effluent from a first reactor of the plurality of reactors in an intermediate separator, the intermediate separator producing a second converted vapor product and an second unconverted slurry product; and
directing the second unconverted slurry product into a second reactor of the plurality of reactors.

8. The method of claim 7, further comprising conveying the second converted vapor product to one of: (i) a cyclone separator, (ii) a cooling unit, and (iii) a fixed bed Gas Phase reactor.

9. The method of claim 7, wherein at least one of the plurality of serially aligned reactors is configured to receive one of: (i) a carbonaceous additive, and (ii) hydrogen.

10. The method of claim 7, wherein the intermediate separator reduces hydrocarbon vapor in the effluent received from the first reactor.

11. The method of claim 7, wherein at least one of the plurality of serially aligned reactors includes a bubble column allowing entry from a bottom of the bubble column one of: (i) a hydrocarbon, (ii) hydrogen, and (iii) an additive.

12. The method of claim 7, further comprising supplying a hydrogen feed to the second unconverted residue and solids product slurry.
